(19) United States
(12) Patent Application Publication
(10) Pub. No.: US 2025/0067589 A1
(43) Pub. Date: Feb. 27, 2025

(54) SYSTEMS AND METHODS FOR VISION-BASED MEASUREMENT OF LIQUID LEVEL IN CONTAINERS HAVING LINEAR SCALES

(71) Applicant: Tata Consultancy Services Limited, Mumbai (IN)

(72) Inventors: PARVESH SAINI, Pune (IN); SOUMYADIPTA MAITI, Pune (IN); BEENA RAI, Pune (IN)

(73) Assignee: Tata Consultancy Services Limited, Mumbai (IN)

(21) Appl. No.: 18/790,355

(22) Filed: Jul. 31, 2024

(30) Foreign Application Priority Data
Aug. 21, 2023 (IN) 202321055988

(51) Int. Cl. G01F 23/80; G01F 23/00

(52) U.S. Cl. CPC G01F 23/802; G01F 23/0007

(57) ABSTRACT

Conventionally, mechanical methods of measuring linear position over a scale required physical coupling with system(s), such as potentiometer-based feedback etc. Such kinds of mechanical feedback mechanisms need geared coupling. And along with a mechanical system comes problems of wear and tear of parts which can lead to increased inaccuracy of the setup over time. With increased capabilities of computer vision-based techniques, a non-contact image-based measurement of linear position has become of prime importance. Embodiments of the present disclosure provide system and method that implement direct visual measurement of liquid level inside a linear measurement setup (syringe here) by employing various techniques such as computer vision, machine learning techniques, and the like, wherein various features are extracted that in turn allow to have a measurement of a liquid level identified or indicator (plug/meniscus) position in a syringe/container.

### PRIORITY CLAIM

This U.S. patent application claims priority under 35 U.S.C. § 119 to: Indian Patent Application number 202321055988, filed on Aug. 21, 2023. The entire contents of the aforementioned application are incorporated herein by reference.

### TECHNICAL FIELD

The disclosure herein generally relates to liquid level measurement techniques, and, more particularly, to systems and methods for vision-based measurement of liquid level in containers having linear scales.

### BACKGROUND

Mechanical methods of measuring linear position over a scale require physical coupling with system(s), such as potentiometer-based feedback etc. Such kinds of mechanical feedback mechanisms need geared coupling. And along with a mechanical system comes problems of wear and tear of parts which can lead to increased inaccuracy of the setup over time.

### SUMMARY

Embodiments of the present disclosure present technological improvements as solutions to one or more of the above-mentioned technical problems recognized by the inventors in conventional systems.

For example, in one aspect, there is provided a processor implemented method for vision-based measurement of liquid level in containers having linear scales. The method comprises receiving, via one or more hardware processors, a Red Green Blue (RGB) image of a liquid container having a measuring scale from a video capturing; pre-processing, via the one or more hardware processors, the RGB image to obtain a pre-processed image; performing, via the one or more hardware processors, a color-based image segmentation on the pre-processed image based on a range of pixel values comprised therein to obtain a segmented image; analyzing, via the one or more hardware processors, one or more edges of the segmented image to obtain one or more closed contours with one or more associated properties; identifying, via the one or more hardware processors, a liquid level identifier in the segmented image based on the one or more closed contours with the one or more associated properties; fitting, via the one or more hardware processors, a regression-based straight line through one or more coordinates of the one or more closed contours to obtain a set of linear features and a set of non-linear features; arranging, via the one or more hardware processors, each linear feature amongst the set of linear features in a pre-defined order and calculating a length between each linear feature and a subsequent linear feature; obtaining, via the one or more hardware processors, a first set of markers and a second set of markers based on the calculated length; identifying, by using an Optical Character Recognition (OCR) technique via the one or more hardware processors, an integer value pertaining to each marker from the first set of markers based on at least one of the set of non-linear features and the second set of markers to obtain a set of integer values; autocorrecting, via the one or more hardware processors, at least a subset of set of integer values to obtain a set of correct values for the first set of markers; and identifying, via the one or more hardware processors, a liquid level value based on the set of correct values and a position of the liquid level identifier.

In an embodiment, the step of autocorrecting at least a subset of set of integer values comprises forming one or more combinations of the set of integer values; calculating a slope for each combination amongst the one or more combinations; determining number of combinations having a matching slope to obtain the set of correct values; and determining a correct value for an incorrect value being identified, wherein the incorrect value identified is based on a linear relationship of the set of correct values associated with the first set of markers.

In an embodiment, the liquid level value is identified based on an interpolation relation of the set of correct values and the position of the liquid level identifier.

In an embodiment, the liquid level identifier is at least one of a rubber plug, a meniscus, and a floating object.

In another aspect, there is provided a processor implemented system for vision-based measurement of liquid level in containers having linear scales. The system comprises: a memory storing instructions; one or more communication interfaces; and one or more hardware processors coupled to the memory via the one or more communication interfaces, wherein the one or more hardware processors are configured by the instructions to receive a Red Green Blue (RGB) image of a liquid container having a measuring scale from a video capturing; pre-process the RGB image to obtain a pre-processed image; perform a color-based image segmentation on the pre-processed image based on a range of pixel values comprised therein to obtain a segmented image; analyze one or more edges of the segmented image to obtain one or more closed contours with one or more associated properties; identify a liquid level identifier in the segmented image based on the one or more closed contours with the one or more associated properties; fit a regression-based straight line through one or more coordinates of the one or more closed contours to obtain a set of linear features and a set of non-linear features; arrange each linear feature amongst the set of linear features in a pre-defined order and calculating a length between each linear feature and a subsequent linear feature; obtain a first set of markers and a second set of markers based on the calculated length; identify, by using an Optical Character Recognition (OCR) technique, an integer value pertaining to each marker from the first set of markers based on at least one of the set of non-linear features and the second set of markers to obtain a set of integer values; autocorrect at least a subset of set of integer values to obtain a set of correct values for the first set of markers; and identify a liquid level value based on the set of correct values and a position of the liquid level identifier.

In an embodiment, the step of autocorrecting at least a subset of set of integer values comprises forming one or more combinations of the set of integer values; calculating a slope for each combination amongst the one or more combinations; determining number of combinations having a matching slope to obtain the set of correct values; and determining a correct value for an incorrect value being identified, wherein the incorrect value identified is based on a linear relationship of the set of correct values associated with the first set of markers.

In an embodiment, the liquid level value is identified based on an interpolation relation of the set of correct values and the position of the liquid level identifier.

In an embodiment, the liquid level identifier is at least one of a rubber plug, a meniscus, and a floating object.

In yet another aspect, there are provided one or more non-transitory machine-readable information storage mediums comprising one or more instructions which when executed by one or more hardware processors cause a vision-based measurement of liquid level in containers having linear scales by receiving a Red Green Blue (RGB) image of a liquid container having a measuring scale from a video capturing; pre-processing the RGB image to obtain a pre-processed image; performing a color-based image segmentation on the pre-processed image based on a range of pixel values comprised therein to obtain a segmented image; analyzing one or more edges of the segmented image to obtain one or more closed contours with one or more associated properties; identifying a liquid level identifier in the segmented image based on the one or more closed contours with the one or more associated properties; fitting a regression-based straight line through one or more coordinates of the one or more closed contours to obtain a set of linear features and a set of non-linear features; arranging each linear feature amongst the set of linear features in a pre-defined order and calculating a length between each linear feature and a subsequent linear feature; obtaining a first set of markers and a second set of markers based on the calculated length; identifying, by using an Optical Character Recognition (OCR) technique, an integer value pertaining to each marker from the first set of markers based on at least one of the set of non-linear features and the second set of markers to obtain a set of integer values; autocorrecting at least a subset of set of integer values to obtain a set of correct values for the first set of markers; and identifying a liquid level value based on the set of correct values and a position of the liquid level identifier.

In an embodiment, the step of autocorrecting at least a subset of set of integer values comprises forming one or more combinations of the set of integer values; calculating a slope for each combination amongst the one or more combinations; determining number of combinations having a matching slope to obtain the set of correct values; and determining a correct value for an incorrect value being identified, wherein the incorrect value identified is based on a linear relationship of the set of correct values associated with the first set of markers.

In an embodiment, the liquid level value is identified based on an interpolation relation of the set of correct values and the position of the liquid level identifier.

In an embodiment, the liquid level identifier is at least one of a rubber plug, a meniscus, and a floating object.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1 depicts an exemplary system for a vision-based measurement of liquid level in containers having linear scales, in accordance with an embodiment of the present disclosure.

FIG. 2 depicts an exemplary flow chart illustrating a method for a vision-based measurement of liquid level in containers having linear scales, using the system of FIG. 1, in accordance with an embodiment of the present disclosure.

FIG. 3 depicts an exemplary container having linear scales as used by the system of FIG. 1 for the vision-based measurement of liquid level comprised therein, in accordance with an embodiment of the present disclosure.

FIG. 4 depicts a color-based image segmentation of the container with one or more relevant parts (also referred to as masked portions), in accordance with an embodiment of the present disclosure.

FIG. 5 depicts closed contours along with their properties, in accordance with an embodiment of the present disclosure.

FIG. 6 depicts containers with different liquid level indicators detected as (a) Plug, and (b) Meniscus, in accordance with an embodiment of the present disclosure.

FIG. 7A depicts the container and associated major markers being separated and shown in a masked version, in accordance with an embodiment of the present disclosure.

FIG. 7B depicts the container with major markers detected successfully for different scale, (a) 0.6, and (b) 1.5 of a segmented image (relative marker identification), in accordance with an embodiment of the present disclosure.

FIG. 8 depicts read digits shown with corresponding markers along with masked version, in accordance with an embodiment of the present disclosure.

FIG. 9 depicts the container with auto-corrected level digits (values) shown alongside misread values by the Optical Character Recognition (OCR) technique as implemented by the system of FIG. 1, in accordance with an embodiment of the present disclosure.

FIG. 10 depicts a calculated value of liquid level based on a position of the liquid level identifier (e.g., plug position) in the container, in accordance with an embodiment of the present disclosure.

FIG. 11 depicts a graphical representation illustrating a comparison for reading from manual versus vision-based measurement of syringe plug, in accordance with an embodiment of the present disclosure.

FIG. 12 depicts a graphical representation illustrating a comparison for manual versus vision-based measurement of liquid surface meniscus, in accordance with an embodiment of the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the scope of the disclosed embodiments.

As mentioned, mechanical methods of measuring linear position over a scale require physical coupling with system(s), such as potentiometer-based feedback etc. Such kinds of mechanical feedback mechanisms need geared coupling. Along with a mechanical system comes problems of wear and tear of parts which can lead to increased inaccuracy of the setup over time. With increased capabilities of computer vision-based techniques, a non-contact image-based measurement of linear position has become of prime importance. Embodiments of the present disclosure provide system and method that implement direct visual measurement of liquid level inside a linear measurement setup (syringe here) by employing various techniques such as computer vision, machine learning techniques, and the like, wherein various features are extracted that in turn allow to have a measurement of a liquid level identified or indicator (plug/meniscus) position in a syringe/container.

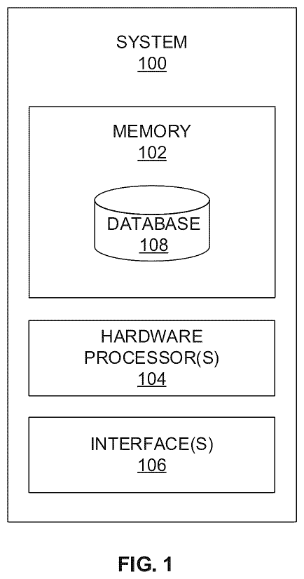

Referring now to the drawings, and more particularly to FIGS. 1 through 12, where similar reference characters denote corresponding features consistently throughout the figures, there are shown preferred embodiments and these embodiments are described in the context of the following exemplary system and/or method.

FIG. 1 depicts an exemplary system 100 for a vision-based measurement of liquid level in containers having linear scales, in accordance with an embodiment of the present disclosure. In an embodiment, the system 100 may also referred as ‘measurement system’ and may be interchangeably used herein after. In an embodiment, the system 100 includes one or more hardware processors 104, communication interface device(s) or input/output (I/O) interface(s) 106 (also referred as interface(s)), and one or more data storage devices or memory 102 operatively coupled to the one or more hardware processors 104. The one or more processors 104 may be one or more software processing components and/or hardware processors. In an embodiment, the hardware processors can be implemented as one or more microprocessors, microcomputers, microcontrollers, digital signal processors, central processing units, state machines, logic circuitries, and/or any devices that manipulate signals based on operational instructions. Among other capabilities, the processor(s) is/are configured to fetch and execute computer-readable instructions stored in the memory. In an embodiment, the system 100 can be implemented in a variety of computing systems, such as laptop computers, notebooks, hand-held devices (e.g., smartphones, tablet phones, mobile communication devices, and the like), workstations, mainframe computers, servers, a network cloud, and the like.

The I/O interface device(s) 106 can include a variety of software and hardware interfaces, for example, a web interface, a graphical user interface, and the like and can facilitate multiple communications within a wide variety of networks N/W and protocol types, including wired networks, for example, LAN, cable, etc., and wireless networks, such as WLAN, cellular, or satellite. In an embodiment, the I/O interface device(s) can include one or more ports for connecting a number of devices to one another or to another server.

The memory 102 may include any computer-readable medium known in the art including, for example, volatile memory, such as static random-access memory (SRAM) and dynamic-random access memory (DRAM), and/or non-volatile memory, such as read only memory (ROM), erasable programmable ROM, flash memories, hard disks, optical disks, and magnetic tapes. In an embodiment, a database 108 is comprised in the memory 102, wherein the database 108 comprises information pertaining to RGB images captured from image/video capturing devices, wherein the RGB images captured pertain to containers having linear scales, and the like. The database 108 further comprises information pertaining to pre-processed images, segmented images, closed contours being detected, liquid level identifier present in the container, linear features, non-linear features extracted therebetween, various markers (major, minor markers, etc.), liquid level value, and the like. The memory 102 comprises various techniques as known in the art to enable the system 100 to perform the method of the present disclosure. For instance, the various techniques include but are not limited to, pre-processing technique, color-based image segmentation technique, closed contour detection technique(s), regression-based straight line fitting technique(s), feature extraction technique(s), marker identification technique(s), optical character recognition (OCR) technique(s), integer value identification technique, liquid level value identification technique(s), and the like. The memory 102 further comprises (or may further comprise) information pertaining to input(s)/output(s) of each step performed by the systems and methods of the present disclosure. In other words, input(s) fed at each step and output(s) generated at each step are comprised in the memory 102 and can be utilized in further processing and analysis.

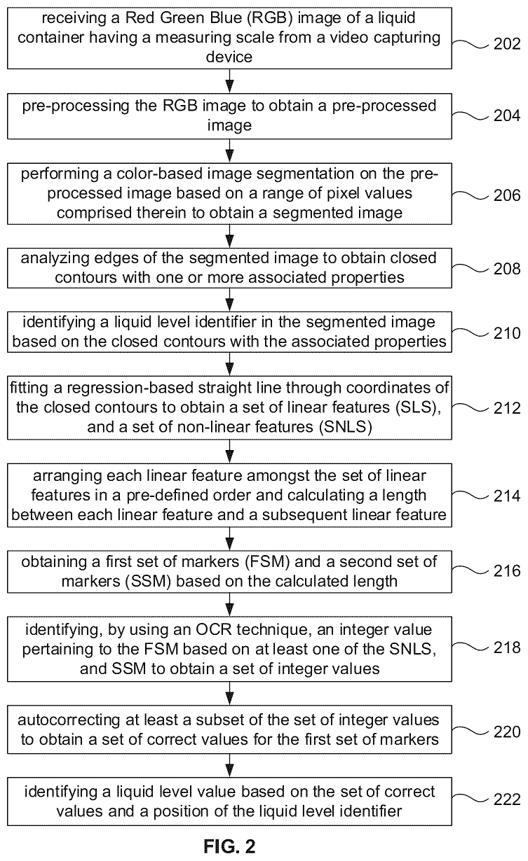

FIG. 2, with reference to FIG. 1, depicts an exemplary flow chart illustrating a method for a vision-based measurement of liquid level in containers having linear scales, using the system 100 of FIG. 1, in accordance with an embodiment of the present disclosure. In an embodiment, the system(s) 100 comprises one or more data storage devices or the memory 102 operatively coupled to the one or more hardware processors 104 and is configured to store instructions for execution of steps of the method by the one or more processors 104. The steps of the method of the present disclosure will now be explained with reference to components of the system 100 of FIG. 1, and the flow diagram as depicted in FIG. 2. Although steps of the method of FIG. 2 including process steps, method steps, techniques or the like may be described in a sequential order, such processes, methods, and techniques may be configured to work in alternate orders. In other words, any sequence or order of steps that may be described does not necessarily indicate a requirement that the steps be performed in that order. The steps of processes described herein may be performed in any practical order. Further, some steps may be performed simultaneously, or some steps may be performed alone or independently.

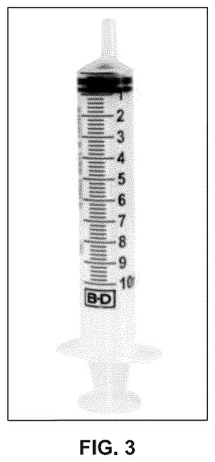

At step 202 of the method of the present disclosure, the one or more hardware processors 104 receive a Red Green Blue (RGB) image of a liquid container having a measuring scale from a video capturing device. At step 204 of the method of the present disclosure, the one or more hardware processors 104 pre-process the RGB image to obtain a pre-processed image. With increased capabilities of computer vision-based techniques, it is now possible to have a non-contact image-based measurement of linear position. In the present disclosure, the system 100 and the method 100 perform a direct visual measurement of level inside a linear measurement setup (e.g., a syringe here) is tried using various techniques such as computer vision, machine learning techniques, and the like. This is done by performing a series of steps, which were used to extract various features that in turn allow the system 100 and method to have a measurement of a level indicator (plug) position in the syringe. One or more frames from a video live feed from a camera (e.g., image/video capturing device) is read in form of the RGB image, container such as syringe is depicted in FIG. 3 (refer step 202). Other examples of containers include, liquid bottles, or packages/cans containing liquid and having linear scales. The first preprocessing operation is carried out wherein the conversion of the color space from RGB to BGR. BGR is essentially in reverse of RGB and with no adverse effect on color vibrancy and accuracy. Then Gaussian blur is applied to the RGB image/frame which helps in reducing noise and results in smoother edges to help in edge detection algorithms (stored in the memory 102 and invoked for execution accordingly). More specifically, FIG. 3, with reference to FIGS. 1 through 2, depicts an exemplary container having linear scales as used by the system 100 of FIG. 1 for the vision-based measurement of liquid level comprised therein, in accordance with an embodiment of the present disclosure.

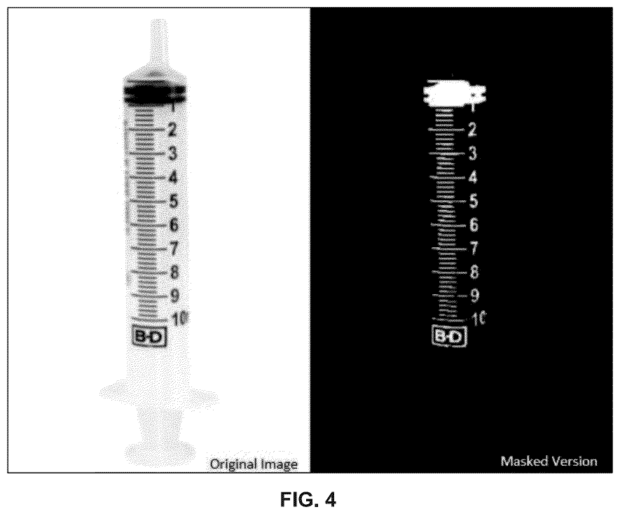

Once the pre-processed image is obtained, at step 206 of the method of the present disclosure, the one or more hardware processors 104 perform a color-based image segmentation on the pre-processed image based on a range of pixel values comprised therein to obtain a segmented image. More specifically, the color-based image segmentation involves extracting one or more relevant parts of the pre-processed image, such as markings (or also referred as markers and may be interchangeably used herein), plunger profiles as depicted in FIG. 4. More specifically, FIG. 4, with reference to FIGS. 1 through 3, depicts a color-based image segmentation of the container with one or more relevant parts (also referred to as masked portions), in accordance with an embodiment of the present disclosure.

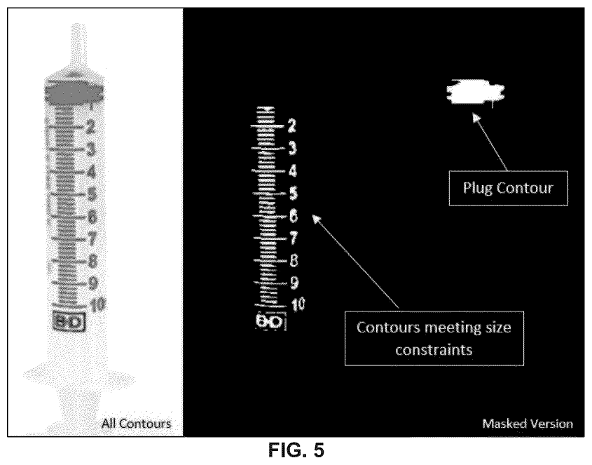

Once the segmented image is obtained, at step 208 of the method of the present disclosure, the one or more hardware processors 104 analyze one or more edges of the segmented image to obtain one or more closed contours with one or more associated properties. In an embodiment, the system 100 and the method employ or execute one or more contour detection algorithms as known in the art for contour detection and/or edge detection. More specifically, the relevant parts (or masked portions) of the segmented image are passed through a contour finding algorithm (stored in the memory 102 and invoked for execution), which analyzes the one or more edges of the segment image and lists all the closed contours detected in the image. FIG. 5, with reference to FIGS. 1 through 4, depicts closed contours along with their properties, in accordance with an embodiment of the present disclosure. In the present disclosure, the one or more associated properties of the one or more closed contours, include, but are not limited to, an associated area, one or more coordinates, one or more perimeters, etc. These properties are then used to separate out different elements of the segmented image like plug and level markers using conditions such as area constraint.

At step 210 of the method of the present disclosure, the one or more hardware processors 104 identify a liquid level identifier in the segmented image based on the one or more closed contours with the one or more associated properties. In the present disclosure, the liquid level identifier is at least one of a rubber plug, a meniscus, and a floating object.

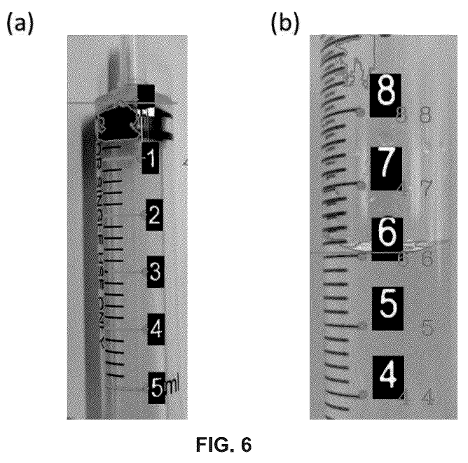

To measure readings from a linear scale, locating liquid level indicator is of great importance. To find a location of the liquid level indicator, type of liquid level identifier present is identified which could be either plug or meniscus. To identify the type of liquid level indicator/identifier, the system 100 and the method described herein perform a plug check on the mask, generated using pixel bound technique and then perform contour determination. If no contour of similar size is found, then plug presence is considered false and the system 100 proceeds with meniscus check. For checking meniscus presence same method is used but with properties (e.g., say pixel bound and size) of the meniscus. FIGS. 6A and 6B (or FIGS. 6(a and b), with reference to FIG. 5, (collectively referred to as FIG. 6) depict containers with different liquid level indicators detected as (a) Plug, and (b) Meniscus, in accordance with an embodiment of the present disclosure.

At step 212 of the method of the present disclosure, the one or more hardware processors 104 fit a regression-based straight line through one or more coordinates of the one or more closed contours to obtain a set of linear features and a set of non-linear features. Among level markers there are two types of contours, one that belongs to level lines and the other to level digits. Therefore, a step involving regression-based straight-line fitting through the contour coordinates has been carried out the system 100 and the method to differentiate between linear and non-linear features. Contours below mean squared error values threshold of say ‘x’ (wherein value of ‘x’ is 6) are considered linear, and others are considered non-linear. Root Mean Square Error (RMSE) was calculated using the following formula.

$$RMSE = \sqrt{\frac{\sum {( {y}_{i} - {\hat{y}}_{i} )}^{2}}{n}}$$

where yᵢ is the actual value at xᵢ coordinate and ŷᵢ is the value calculated at xᵢ using the following expression.

$${\hat{y}}_{i} = m\_contour * {x}_{i} + c\_contour$$

The values of m_contour and c_contour (fitted parameters) were obtained using regression technique.

The following Table 1 contains this RMSE calculation for three example contours along with their classification based on that.

TABLE 1

| Contour Index | RMSE | Classification |
|---|---|---|
| 0 | 4 | Linear (RSME < 6) |
| 1 | 8 | Non-linear (RSME > 6) |
| 2 | 2 | Linear (RSME < 6) |

In the example above, all the contours (or indicated by contour index) with RMSE value less than 6 are considered as linear features and all above 6 as non-linear features.

At step 214 of the method of the present disclosure, the one or more hardware processors 104 arrange each linear feature amongst the set of linear features in a pre-defined order and calculate a length between each linear feature and a subsequent linear feature. At step 216 of the method of the present disclosure, the one or more hardware processors 104 obtain a first set of markers (e.g., say major markers) and a second set of markers (e.g., say minor markers) based on the calculated length. The steps 214 and 216 are better understood by way of following description:

Depending on a distance from the image/video capturing device (e.g., camera), contours can appear to be of different sizes in the Red Green Blue (RGB) image (or the pre-processed image/the segmented image). So, to separate out contours of major markers, a relative classification approach (classification method as known in the art) was chosen by the system 100 and method. In this all the linear contours found were arranged in the order of decreasing length (e.g., the pre-defined order) and jump in length of consecutive contours were calculated wherein contours are referred to as collection of coordinates of which length is calculated. Below Table 2 depicts contours (index) arranged in the decreasing order of their lengths, along with the consecutive jump (percentage to previous length) in length. Now, if the jump is more than set value, 15% here, new group is created.

TABLE 2

| Linear | | | |
|---|---|---|---|
| Contour | | Percentage | |
| S. no | Length | Jump | Classification |
| 0 | 73 | — | Major marker |
| 5 | 72 | 1.36 | Major marker |
| 15 | 68 | 5.55 | Major marker |
| 20 | 66 | 2.29 | Major marker |
| 10 | 31 | 19.0 | Minor marker (Group |
| | | | changed because jump is |
| | | | more than 15%) |
| 12 | 31 | 0 | Minor marker |
| 14 | 30 | 1.15 | Minor marker |

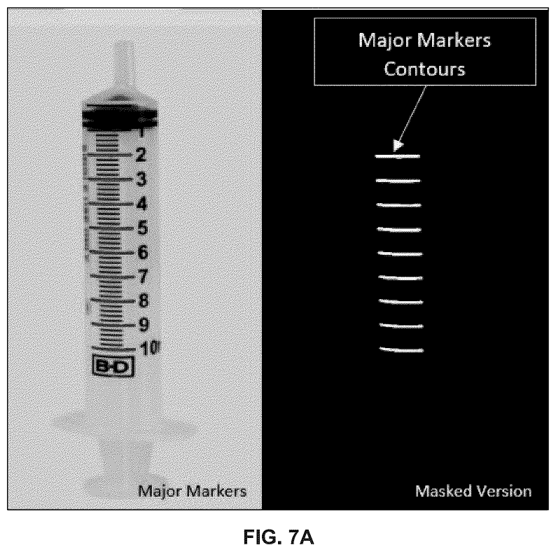

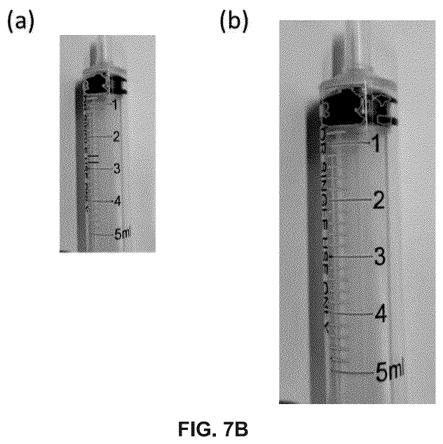

The contours based on the relative lengths are grouped together. In the present disclosure, the grouping is done by checking whether the calculated jump is more than p % (e.g., say p=15%) of the length of the last contour, then a new group is created. This results in separate groups consisting of major and minor markers, major being the first one due to sorting. Then all the contours in the first group are passed for further processing as contours of the major markers. FIG. 7A, with reference to FIGS. 1 through 6B, depicts the container and associated major markers being separated and shown in a masked version, in accordance with an embodiment of the present disclosure. FIG. 7B, with reference to FIGS. 1 through 7A, depicts the container with major markers detected successfully for different scale, (a) 0.6, and (b) 1.5 of the segmented image (relative marker identification), in accordance with an embodiment of the present disclosure.

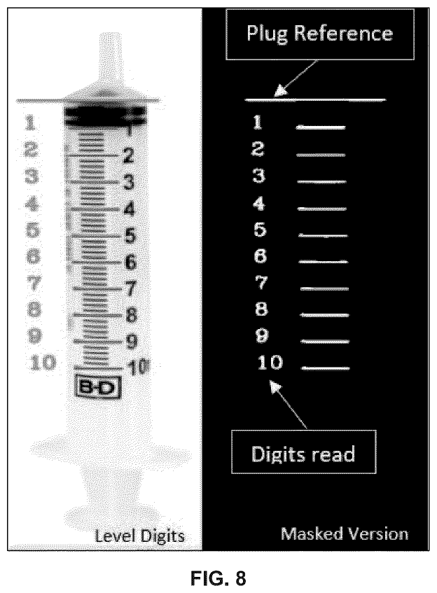

At step 218 of the method of the present disclosure, the one or more hardware processors 104 identify, by using an Optical Character Recognition (OCR) technique (as known in the art such as Tesseract—an optical character recognition engine for various operating systems), an integer value pertaining to each marker from the first set of markers based on at least one of the set of non-linear features and the second set of markers to obtain a set of integer values. Once contours corresponding to the level digits are identified based on contour linearity check, these need to be read for their corresponding values. This task is done by cropping a nearby portion of the segmented image. Now this cropped portion of the segmented image is passed through the Optical Character Recognition (OCR) technique. Here, Tesseract OCR as known in the art is used by the system 100 and the method that gives the corresponding integer value, and then the integer value is associated with a nearest linear level marker. Read digits can be seen written along major markers FIG. 8. More specifically, FIG. 8, with reference to FIGS. 1 through 7B, depicts read digits shown with corresponding markers along with masked version, in accordance with an embodiment of the present disclosure.

At step 220 of the method of the present disclosure, the one or more hardware processors 104 autocorrect at least a subset of set of integer values to obtain a set of correct values for the first set of markers. More specifically, during autocorrection, the system 100 and the method first form one or more combinations of the set of integer values. A slope is then calculated for each combination amongst the one or more combinations. Further, the system 100 determines number of combinations having a matching slope to obtain the set of correct values and the same is stored in a list. In this list the most repeated (mode) slope value is then found out, which is the correct value of slope in the linear relationship of value and position. The offset of the linear relationship can be further calculated using any of the points having correct slope. For example, if the most repeated (mode) slope value is 0.10, thus the correct slope. Now, using any point from the combinations, where slope is correct, offset in the linear relation {y=slope*x+offset} is determined for the frame. Using this relation, the points which gave the incorrect values for the slope due to incorrect OCR reading are replaced with the correct value (correct y values) as the positions (x values) of those points are known. For each incorrect value, the system 100 further determines a correct value. The incorrect value identified is based on a linear relationship of the set of correct values associated with the first set of markers (major markers). The above step 220 of autocorrection and its sub-steps may be better understood by way of following description:

Digits read by OCR are not read correctly all the time and can have misread values. These misread values can lead to incorrect measured reading, which in turn can affect the controls of the system 100 or any other system(s) connected to (or integrated with) the system 100. Therefore, an autocorrection is needed to detect and correct misread values. To do this the position (from co-ordinates of the major marker contours) and value (read using OCR) of the digits are read and converted into pairs. All possible combinations of points such as position of major marker, OCR read integers were generated as a list using the “COMBINATIONS” method in python, which took all points as input and generated a list of all possible pairs from it. For example, if a total of 4 points are available with index {0, 1, 2, 3, 4}, combinations would be {(0, 1), (0, 2), (0, 3), (1, 2), (1, 3), (2, 3)}, where each index pertains to a representation of a point (say a position of a linear feature (e.g., major marker), a value at that feature/major marker). And for each pair of data points (e.g., say (x1, y1), (x2, y2)) slopes are calculated using formula {(y2−y1)/(x2−x1)} and rounded off, accordingly. This slope value is noted along with the pair for which it is calculated in form of a matrix, in an embodiment of the present disclosure. In this list of slopes, mode (most occurring value) is calculated for the correct slope, as most of the combination being in a linear relationship would be giving same values except the ones having incorrectly read OCR value. Now, based on the combinations which have the matching slope, correct values were listed, and wrong ones were rejected. For example, Table 3 depicts combinations of points and their corresponding slope value. The most repeated value of the slope here is 0.10 thus the correct slope. Thus, the combinations where slope values are 0.10 are classified as Correct and others as Incorrect.

TABLE 3

| | Slope | |
|---|---|---|
| | {(y2 − | |
| | y1)/(x2 − | |
| Combination | x1)} and | |
| (index of | rounded | |
| markers) | off | Classification |
| (0, 1) | 0.10 | Correct |
| (0, 2) | 0.20 | Incorrect |
| (0, 3) | 0.10 | Correct |
| (1, 2) | 0.30 | Incorrect |
| (1, 3) | 0.10 | Correct |
| (2, 3) | 0.00 | Incorrect |

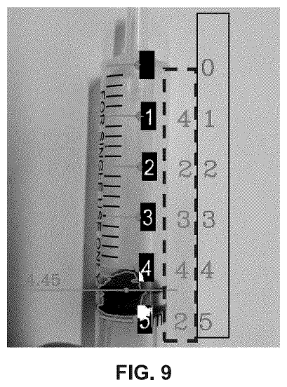

Using these correct values, a linear relationship of position and value was calculated. And by using this linear relationship, correct values corresponding to all the incorrect values, were determined, and replaced accordingly. FIG. 9, with reference to FIGS. 1 through 8, depicts the container with auto-corrected level digits (values) shown alongside misread values by the Optical Character Recognition (OCR) technique as implemented by the system 100 of FIG. 1, in accordance with an embodiment of the present disclosure. In FIG. 9, the digits/values read by the OCR technique are depicted in broken line property, and the corrected values in solid line property. OCR technique is required to make systems such as computer systems understand or read the image of a digit, which is written beside/nearby every major marker. Without this capability, the computing/computer systems would not know which major maker represents what value. As fixed distance or fixed syringe setup is not used in the present disclosure, a fixed distance is not possible to volume relation. Thus, the system 100 needs to calculate this on its own. To calculate this relation, the system 100 needs to know at what location of major marker (calculated separately using contour analysis) what volume value is present. For this, the OCT technique when applied needs to provide the “value” (e.g., 2 ml or 4 ml) for each major marker position. Using this obtained data of marker position and its value (read using OCR), the system 100 determines a relation between the position and the value. This relation is needed to get the reading (volume measurement) corresponding to the location of liquid level indicator/identifier (plug in this case). After the relation is obtained, the system 100 can directly determine volume reading corresponding to the liquid level indicator location (found separately). The method of the present disclosure implements various techniques for locating markers and reading associated digits, a calibration free setup can be realized unlike conventional methods/approaches and systems which are limited/restricted to specific set-up.

At step 222 of the method of the present disclosure, the one or more hardware processors 104 identify a liquid level value based on the set of correct values and a position of the liquid level identifier. The liquid level value is identified based on an interpolation relation of the set of correct values and the position of the liquid level identifier.

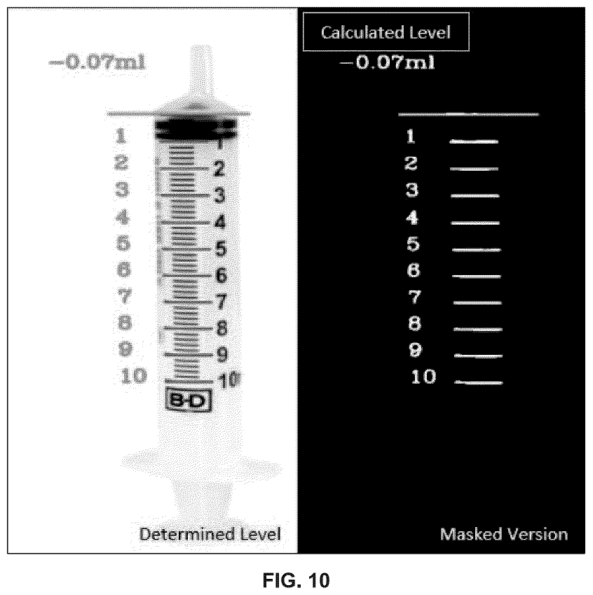

Once all the level markers (e.g., say major markers) are associated with corresponding level values (e.g., say correct values) and correct coordinates for each of those levels are also obtained, a linear relationship is determined between any position in the segmented image/pre-processed image to the indicative level. Now, the liquid level indicator/identifier (plug contour) position is already known and separated earlier based on its size, and its position is also known. This information can be converted to the liquid level value using established interpolation relation. For example, if the linear relationship of position and value comes out to be y=0.10*x+2, then for a plunger position (x) is 50 (refers to pixel location), the value of liquid level would be 7 ml (7 milliliter). FIG. 10, with reference to FIGS. 1 through 9, depicts a calculated value of liquid level based on a position of the liquid level identifier (e.g., plug position) in the container, in accordance with an embodiment of the present disclosure. It is to be understood by a person having ordinary skill in the art or person skilled in the art that not all the time the system 100 is required to perform autocorrection. It may so happen in some scenarios that the integer values as identified by the OCR technique may be correctly identified and thus the autocorrection technique may or may not be invoked for execution. Even though if the autocorrection technique is invoked and if the system 100 determines that the integer values are correct, then the autocorrection technique may be same as that of the OCR technique output. Hence, the liquid level value identification may be based on (i) the OCR technique (output) without actually performing autocorrection and (ii) the position of the liquid level identifier.

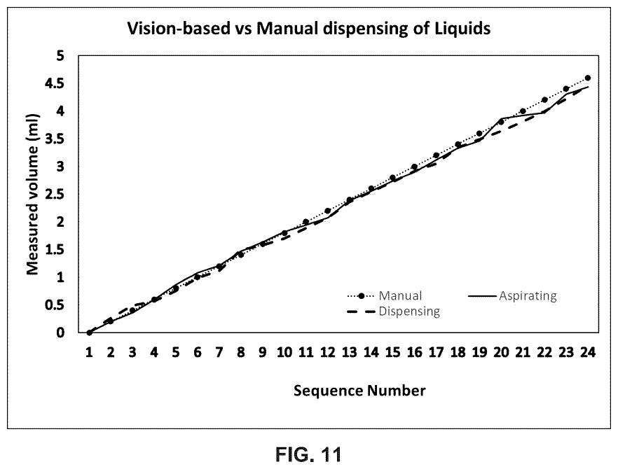

For cross-validation of manual measurements of syringe levels corresponding to each minor and major level markers made, corresponding vision-based reading was noted down as shown in FIG. 11. More specifically, FIG. 11, with reference to FIGS. 1 through 10, depicts a graphical representation illustrating a comparison for reading from manual versus vision-based measurement of syringe plug, in accordance with an embodiment of the present disclosure. The exercise was carried out for both forward and backward movement (downwards and upwards plunger movement) of the syringe plunger. FIG. 11 shows all 3 plots—manual reading, computer vision-based reading while dispensing and vision-based reading while aspirating. As can be seen from FIG. 11, vision-based readings/measurements are very close to what a human can measure. Thus, it can be concluded that a vision-based measurement of the liquid level inside a container (e.g., such as a syringe) is feasible as demonstrated.

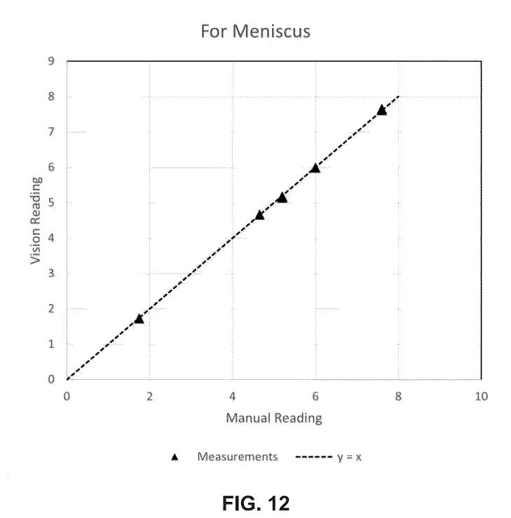

Another set of experiments were also carried out for the liquid level measurement in a measuring cylinder. The liquid level was measured based on the liquid surface meniscus positions (e.g., refer FIG. 6B). Several different images of various liquid levels in the measuring cylinder were analyzed by both manual and the developed vision-based methodologies (not shown in FIGS.). The comparison of liquid meniscus level is presented in FIG. 12. More specifically, FIG. 12, with reference to FIGS. 1 through 11, depicts a graphical representation illustrating a comparison for manual versus vision-based measurement of liquid surface meniscus, in accordance with an embodiment of the present disclosure. It can be noted that the method of the present disclosure works so well that the experimental marker points all fall on the expected y=x graph line for the corresponding X and Y axes of FIG. 12.

As mentioned above, to get the reading the scale needs to be estimated/sensed, so that at what position in the frame what is the level value. For getting the scale, all major marker's locations are located in the frame, because only these major markers have values written in digits corresponding to them. To identify the major markers, all the contours present in the frame are identified and the linear ones are filtered using R2 minimization and aspect ratio feature based classification. After this only linear contours (both major and minor) are left in the list. To classify these linear markers further into the groups of major and minor markers, their lengths were calculated and arranged in the pre-defined order (e.g., decreasing order). After this, subsequent jump in the lengths was calculated moving from top to bottom and when a jump of more than p % (e.g., p=15%) was detected a separate group was made. This resulted in two groups, one having the major markers and the other having the minor markers. To read the values corresponding to major markers the system 100 implemented the OCR technique. To prevent the digit from being associated with a wrong/incorrect marker, the classification of major and minor markers is performed by the system 100 and method of the present disclosure, so that the value gets associated with only the major markers even when it is at some offset to the major marker. In some cases, the level numbers could be closer to a minor marker than a major marker, that should be detected and averted from the further analysis by the system 100 and method of the present disclosure. After reading these digits corresponding to each markers, location of each marker and the value of that marker (digit read using the OCR technique) is known. This data can be viewed as a point (x, y) representing (location, value). The outlier(s) (if any)—in this case 4-5 points, are further identified and corrected accordingly. After correction of these 4-5 points, a linear relation (y=slope*x+offset) of location and value is determined (i.e., value of ‘slope’ and ‘offset’ are determined). Using this relation, the system 100 and the method found the value (y_plug) for the liquid level indicator (plug, location x_plug of which was found separately).

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

It is to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g., any kind of computer like a server or a personal computer, or the like, or any combination thereof. The device may also include means which could be e.g., hardware means like e.g., an application-specific integrated circuit (ASIC), a field-programmable gate array (FPGA), or a combination of hardware and software means, e.g., an ASIC and an FPGA, or at least one microprocessor and at least one memory with software processing components located therein. Thus, the means can include both hardware means and software means. The method embodiments described herein could be implemented in hardware and software. The device may also include software means. Alternatively, the embodiments may be implemented on different hardware devices, e.g., using a plurality of CPUs.

The embodiments herein can comprise hardware and software elements. The embodiments that are implemented in software include but are not limited to, firmware, resident software, microcode, etc. The functions performed by various components described herein may be implemented in other components or combinations of other components. For the purposes of this description, a computer-usable or computer readable medium can be any apparatus that can comprise, store, communicate, propagate, or transport the program for use by or in connection with the instruction execution system, apparatus, or device.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A processor implemented method, comprising:
receiving, via one or more hardware processors, a Red Green Blue (RGB) image of a liquid container having a measuring scale from a video capturing device;
pre-processing, via the one or more hardware processors, the RGB image to obtain a pre-processed image;
performing, via the one or more hardware processors, a color-based image segmentation on the pre-processed image based on a range of pixel values comprised therein to obtain a segmented image;
analyzing, via the one or more hardware processors, one or more edges of the segmented image to obtain one or more closed contours with one or more associated properties;
identifying, via the one or more hardware processors, a liquid level identifier in the segmented image based on the one or more closed contours with the one or more associated properties;
fitting, via the one or more hardware processors, a regression-based straight line through one or more coordinates of the one or more closed contours to obtain a set of linear features, and a set of non-linear features;
arranging, via the one or more hardware processors, each linear feature amongst the set of linear features in a pre-defined order and calculating a length between each linear feature and a subsequent linear feature;
obtaining, via the one or more hardware processors, a first set of markers and a second set of markers based on the calculated length;
identifying, by using an Optical Character Recognition (OCR) technique via the one or more hardware processors, an integer value pertaining to each marker from the first set of markers based on at least one of the set of non-linear features and the second set of markers to obtain a set of integer values;
autocorrecting, via the one or more hardware processors, at least a subset of the set of integer values to obtain a set of correct values for the first set of markers; and
identifying, via the one or more hardware processors, a liquid level value based on the set of correct values and a position of the liquid level identifier.

2. The processor implemented method of claim 1, wherein the step of autocorrecting at least the subset of the set of integer values comprises:
forming one or more combinations of the set of integer values;
calculating a slope for each combination amongst the one or more combinations;
determining number of combinations having a matching slope to obtain the set of correct values; and
determining a correct value for an incorrect value being identified, wherein the incorrect value identified is based on a linear relationship of the set of correct values associated with the first set of markers.

3. The processor implemented method of claim 1, wherein the liquid level value is identified based on an interpolation relation of the set of correct values and the position of the liquid level identifier.

4. The processor implemented method of claim 1, wherein the liquid level identifier is at least one of a rubber plug, a meniscus, and a floating object.

5. A system, comprising:
a memory storing instructions;
one or more communication interfaces; and
one or more hardware processors coupled to the memory via the one or more communication interfaces, wherein the one or more hardware processors are configured by the instructions to:
receive a Red Green Blue (RGB) image of a liquid container having a measuring scale from a video capturing device;
pre-process the RGB image to obtain a pre-processed image;
perform a color-based image segmentation on the pre-processed image based on a range of pixel values comprised therein to obtain a segmented image;
analyze one or more edges of the segmented image to obtain one or more closed contours with one or more associated properties;
identify a liquid level identifier in the segmented image based on the one or more closed contours with the one or more associated properties;
fit a regression-based straight line through one or more coordinates of the one or more closed contours to obtain a set of linear features, and a set of non-linear features;
arrange each linear feature amongst the set of linear features in a pre-defined order and calculate a length between each linear feature and a subsequent linear feature;
obtain a first set of markers and a second set of markers based on the calculated length;
identify, by using an Optical Character Recognition (OCR) technique, an integer value pertaining to each marker from the first set of markers based on at least one of the set of non-linear features and the second set of markers to obtain a set of integer values;
autocorrect at least a subset of the set of integer values to obtain a set of correct values for the first set of markers; and
identify a liquid level value based on the set of correct values and a position of the liquid level identifier.

6. The system of claim 5, wherein the at least the subset of the set of integer values are autocorrected by:
forming one or more combinations of the set of integer values;
calculating a slope for each combination amongst the one or more combinations;
determining number of combinations having a matching slope to obtain the set of correct values; and
determining a correct value for an incorrect value being identified, wherein the incorrect value identified is based on a linear relationship of the set of correct values associated with the first set of markers.

7. The system of claim 5, wherein the liquid level value is identified based on an interpolation relation of the set of correct values and the position of the liquid level identifier.

8. The system of claim 5, wherein the liquid level identifier is at least one of a rubber plug, a meniscus, and a floating object.

9. One or more non-transitory machine-readable information storage mediums comprising one or more instructions which when executed by one or more hardware processors cause:
receiving a Red Green Blue (RGB) image of a liquid container having a measuring scale from a video capturing device;
pre-processing the RGB image to obtain a pre-processed image;
performing a color-based image segmentation on the pre-processed image based on a range of pixel values comprised therein to obtain a segmented image;
analyzing one or more edges of the segmented image to obtain one or more closed contours with one or more associated properties;
identifying a liquid level identifier in the segmented image based on the one or more closed contours with the one or more associated properties;
fitting a regression-based straight line through one or more coordinates of the one or more closed contours to obtain a set of linear features, and a set of non-linear features;
arranging each linear feature amongst the set of linear features in a pre-defined order and calculating a length between each linear feature and a subsequent linear feature;
obtaining a first set of markers and a second set of markers based on the calculated length;
identifying, by using an Optical Character Recognition (OCR) technique, an integer value pertaining to each marker from the first set of markers based on at least one of the set of non-linear features and the second set of markers to obtain a set of integer values;
autocorrecting at least a subset of the set of integer values to obtain a set of correct values for the first set of markers; and
identifying a liquid level value based on the set of correct values and a position of the liquid level identifier.

10. The one or more non-transitory machine-readable information storage mediums of claim 9, wherein the step of autocorrecting at least the subset of the set of integer values comprises:
forming one or more combinations of the set of integer values;
calculating a slope for each combination amongst the one or more combinations;
determining number of combinations having a matching slope to obtain the set of correct values; and
determining a correct value for an incorrect value being identified, wherein the incorrect value identified is based on a linear relationship of the set of correct values associated with the first set of markers.

11. The one or more non-transitory machine-readable information storage mediums of claim 9, wherein the liquid level value is identified based on an interpolation relation of the set of correct values and the position of the liquid level identifier.

12. The one or more non-transitory machine-readable information storage mediums of claim 9, wherein the liquid level identifier is at least one of a rubber plug, a meniscus, and a floating object.
